(19) United States
(12) Patent Application Publication
(10) Pub. No.: US 2009/0128525 A1
(43) Pub. Date: May 21, 2009

(54) LIQUID CRYSTAL DISPLAY DEVICE AND METHOD FOR DRIVING SAME WITH MAKING OF DRIVE VOLTAGES OPPOSITE TO ONE ANOTHER ON THE BASIS OF AN INVERSION PATTERN

(75) Inventor: Junji Kotani, Inagi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/274,008

(22) Filed: Nov. 19, 2008

(30) Foreign Application Priority Data
Nov. 21, 2007 (JP) 2007-301783

(51) Int. Cl. G09G 3/36; G09G 5/00

(52) U.S. Cl. 345/204; 345/96

(57) ABSTRACT

A liquid crystal display device dividing a single frame of an image signal into m fields and driving the signal at m times speed, including (a) a circuit comparing a concerned frame's image signal with that of an immediately preceding frame for each pixel in the first field, and performing correction so the gradation becomes higher or lower than the concerned frame's image signal with an increase or decrease in the gradation, respectively, (b) a circuit generating an inversion pattern for cyclically inverting polarity of a drive voltage applied to a liquid crystal in m/2 fields including the first field, and (c) a circuit making the drive voltage applied to the liquid crystal in m/2 fields including the first field and the drive voltage applied to the liquid crystal in remaining m/2 fields opposite in polarity to each other on the basis of the pattern.

### FIELD OF THE INVENTION

The present invention relates to a liquid crystal display device, and particularly relates to a liquid crystal display device performing overdriving, so as to increase the video display capability, and to a method of driving the above-described liquid crystal display device.

### DESCRIPTION OF THE RELATED ART

Hitherto, liquid crystal projectors including a liquid crystal modulation element, as a two-dimensional optical switch of an image modulation unit, have been available, as projection display devices. The liquid crystal modulation element used for the liquid crystal projector includes, for example, a twisted-nematic (TN) liquid crystal modulation element. According to the TN liquid crystal modulation element, a nematic liquid crystal with positive dielectric anisotropy fills a gap between two substrates. The liquid crystal molecules are twisted 90 degrees continuously between the substrates.

Both transmissive and reflective type liquid crystal light modulators have been used.

According to the transmissive light modulators, the substrates are transparent and transparent electrodes are deposited on the substrates. One of the substrates is provided with active switching elements and wirings that form a driving circuit of the liquid crystal.

The reflective liquid crystal light modulator is comprised of a liquid crystal between a transparent substrate and a reflective substrate. The reflective substrate has a reflecting mirror and active elements and wirings are provided behind the reflective mirror.

Other than the TN liquid crystal device, a vertical alignment nematic (VAN) liquid crystal device is frequently used. In the VAN liquid crystal device, the liquid crystal has negative dielectric anisotropy and aligns vertically to the substrates.

The liquid crystal modulates a polarization state of a light wave during it passes through the liquid crystal. This is due to an electrically controlled birefringence (ECB) effect.

Before incident to the liquid crystal, the light wave is linearly polarized by a polarizer such as a light-beam splitter, which separates the light into two orthogonally polarized beams. Then, the linearly polarized light is incident in the liquid crystal. During it propagates through the liquid crystal, the phase of the light wave is retarded. The amount of retardation depends on the direction of the polarization plane with respect to the liquid crystal alignment direction. A retardation is defined as a phase difference between two light components having mutually orthogonal polarization planes, which determines the polarization state of the light.

The polarization state is changed during the light propagates through the liquid crystal. When the light comes out of the liquid crystal, the polarization plane is rotated from the polarization plane of the incident light. The emitted light is detected by a polarization device located on the light emission path from the liquid crystal. The light is transmitted or absorbed by the polarization device according to the liquid crystal alignment direction. Thus, optical modulation is performed.

The liquid crystal modulator is designed for performing the above-described modulation appropriately to a concerning optical system.

If a reflective liquid crystal device is used normally white, retardation is designed as one half the wavelength for the wavelength of incident light (the centroid wavelength of a given light wavelength band) when no electric field is applied to the liquid crystal.

On the other hand, retardation of a liquid crystal device used normally black should be zero when no electric field is applied to the liquid crystal. On the other hand, while an electric field is applied to the liquid crystal, the retardation should be as half the wavelength, since the polarization plane is rotated at a right angle from the polarization plane of the incident light.

In the liquid crystal modulation element, ionic substances often exist and move due to an electric field applied to the liquid crystal layer. If a direct current electric field is continuously applied to the liquid crystal layer, the ionic substances are drawn to one of two electrodes depending on the charge of ions. When a DC voltage is applied to the electrode, the electric field applied to the liquid crystal layer is attenuated by the ionic charge.

For avoiding the above-described problems, the voltage applied to the electrodes is inverted periodically. The line inversion drive method has been available, in which the polarity of the voltage applied to the matrix-arranged pixels alters line by line at 60 Hz. The dot inversion drive method is also adopted, in which the polarity of the voltage applied to a pixel is opposite to the polarity of the voltage applied to adjacent pixels and also inverted temporary at 120 Hz. By inverting the polarity of the applied voltage, the ions are prevented from being biased.

Overdriving technique is known as a driving method attained to increase the display quality of a liquid crystal layer. The overdriving allows for correcting the driving voltage, so as to excessively increase the driving amount, in accordance with the difference between the gradations of two fields adjacent to each other in terms of time when performing driving so that the gradation changes with time. Namely, if the gradation increases, the liquid crystal display element is driven at a gradation greater than the original display gradation, as the increased gradation.

Further, if the gradation decreases, the liquid crystal display element is driven at a gradation smaller than the original display gradation, as the decreased gradation. By performing the above-described driving, the response speed attained in the liquid crystal in a halftone is improved, which reduces blurred images occurring during the video display.

However, when video is continuously displayed on the liquid crystal display element by performing the overdriving, direct current voltage components are applied to the liquid crystal layer on the average over a long time period. This is because the absolute value of the amount of the voltage applied to the liquid crystal is out of balance at the time when a certain gradation difference is attained. Namely, the amount corresponding to the amount of overdrive correction in the increasing direction, and the amount corresponding to the amount of overdrive correction in the decreasing direction, are out of balance.

Suppose that a dark state and a certain halftone are alternately displayed at regular intervals over a predetermined time period. The overdrive voltage is applied when the gradation changes from the dark state, where no voltage is applied, to the halftone state. At that time, when the gradation is changed from the halftone to the dark state, the value of the voltage corresponding to the overdrive amount becomes zero. The above-described unbalance of the voltage application becomes significant when a video image of continuous scanning of a strip is produced on the screen image, when the unbalance occurs accumulatively.

In a direct view type liquid crystal panel, countermeasures attained through driving are taken against the DC voltages applied to the liquid crystal layer. Namely, cancellation is performed for each of adjacent lines, for example, as the pixel average. For example, the countermeasures are attained by using driving methods including (a) the line inversion driving which allows for applying a voltage opposed in polarity to the immediately preceding voltage for each of adjacent lines of a display electrode and/or (b) the dot inversion driving which allows for applying a voltage opposed in polarity to the immediately preceding voltage for each of adjacent dots.

However, in a liquid crystal display device using a micro display such as a projection display device, unusual alignment of liquid crystal occurs due to the execution of the line inversion driving and the dot inversion driving, which affects a displayed image. In recent years, therefore, the use of the field inversion driving which allows for driving a single field in the same polarity is increased, which makes it difficult to ignore the problem of the direct current voltage component application occurring during the overdriving.

Overdriving performed in the dot (field) inversion driving will be described with reference to FIG. 9. FIG. 9 shows a temporal change in the gradation of an input image signal for a single pixel of the liquid crystal display device. According to an example shown in FIG. 9, there are consecutive eight frames of 1/60 second, that is, FRAMES 1, 2, 3, 4, 5, 6, 7, and 8. The individual eight frames indicate the gradation degrees 11, 12, 13, 14, 15, 16, 17, and 18. The gradation degree 11 indicates the dark state, the gradation degrees 12 to 15 indicate that the gradation is on the increase, and the gradation degrees 16 to 18 indicate that the gradation is on the decrease.

When ordinary driving is performed, an alternating current drive electric field is applied to the liquid crystal layer of the corresponding pixel part, as shown in FIG. 10A. The alternating current waveform is achieved by dividing the input image signal into a field in which electric field writing is performed in positive polarity and a field in which the electric field writing is performed in negative polarity in each frame, and performing the driving for each of the fields alternately.

According to the above-described example, voltages 211, 221, 231, 241, 251, 261, 271, and 281 that are shown in the positive polarity field and voltages 212, 222, 232, 242, 252, 262, 272, and 282 that are shown in the negative polarity field are alternately applied. The above-described alternating current driving allows for reducing the application of a direct current voltage to the liquid crystal layer and the occurrence of sticking and/or flicker. Voltages applied to the liquid crystal layer in a single field (i.e., a single screen image) are of the same polarity. After the electric field writing to the liquid crystal corresponding to the pixels of the entire single field is finished, signals of the opposite polarity are written in the next field, whereby the field inversion driving is achieved.

Here, since the liquid crystal layer indicates the gradation response corresponding to the absolute value of a drive voltage, an optical response is indicated by the brightness fluctuation corresponding to the amplitude of the voltage applied to the liquid crystal, as indicated by a broken line 301 shown in FIG. 11. Since a liquid crystal response has a certain time constant, a change in the display gradation becomes gentle when compared to a transmitted image signal. Consequently, when video display or the like is performed through the ordinary driving, blurred motion is visually recognized.

On the other hand, when the overdriving is performed, the waveform of a voltage applied to the liquid crystal layer of the pixel part is indicated by a solid line shown in FIG. 10B, in comparison with FIG. 10A showing an example where ordinary liquid crystal driving is performed. The liquid crystal drive voltage of a field shown immediately after a shift in the gradation change toward an increasing direction is driven with an amplitude larger than the voltage of the display gradation. Namely, the driving is performed by increasing the voltages 221, 231, 241, and 251 of the ordinary driving by as much as 221A, 231A, 241A, and 251A, respectively.

Similarly, in a field which is shown immediately after a shift in the gradation change toward a decreasing direction, the driving is performed with an amount smaller than the voltage of the display gradation. That is to say, the driving is performed by decreasing the voltages 261 and 271 of the display gradation by as much as 261A and 271A. An optical response property obtained by performing the above-described driving achieves a rise and a fall that are shown by a solid line 302 shown in FIG. 11, which rise and fall are steeper than a rise and a fall that are shown by a broken line 301 shown in FIG. 11, the rise and the fall being achieved by an optical response property obtained by performing the ordinary driving.

Here, when the overdrive correction amount is excessively increased, an overshoot of the brightness occurs. In that case, the outline of a video object is unnaturally emphasized on a display screen image. Therefore, it is preferable that the most appropriate overdrive amount be selected, so as to make full use of the effect of the overdriving and reduce the display problems. It has been known that the most appropriate overdrive amount has a value varying in accordance with the combinations of the gradation changes. Thus, blurred images produced during the video display can be reduced by performing the overdriving during the field inversion driving.

However, the overdrive correction amount in the rise direction and that in the fall direction are out of balance, as described above. That is to say, the accumulated amount of the rise direction voltage correction is not equivalent to that of the fall direction voltage correction. In the example shown in FIG. 10B, the value of the following voltage difference is not zero, and the voltage difference becomes a direct current voltage component obtained in the eight frames including FRAME 1 to 8, by the following formula:

(221A+231A+241A+251A)(261A+271A)

When the overdriving is continued as described above, voltage differences caused by the overdrive correction amounts that are out of balance are accumulated, and direct current voltage components are accumulatively applied. Further, when a dark gradation is displayed after displaying a halftone, the value of the minus component of the above-described expression becomes zero, which generates a pattern in which the direct current voltage component is significantly increased.

Japanese Patent No. 3407698 discloses a technology, as countermeasures taken against the application of the direct current voltage component to the liquid crystal element, for example. Japanese Patent No. 3407698 points out the following problem. Namely, ions are generated from the electrode material due to the application of a direct current voltage component, the application being performed due to the execution of the overdriving, so that a spot occurs.

Japanese Patent No. 3407698 discloses a technology to prevent the generation of ions from the electrode material by changing the electrode material from chromium (Cr) to indium tin oxide (ITO), as a structural contrivance.

When a direct current voltage component is applied to a liquid crystal layer, the occurrence of sticking and/or flicker arises in addition to the spot occurrence described in Japanese Patent No. 3407698, which may decrease the display quality. Therefore, the application of the direct current voltage component to the liquid crystal layer should be eliminated, so as to maintain the display quality with stability.

### SUMMARY OF THE INVENTION

The present invention provides a liquid crystal display device capable of substantially eliminating a direct current voltage component applied to a liquid crystal layer while performing driving which allows for increasing the video response capability through the use of overdriving.

According to an aspect of the present invention, a liquid crystal display device configured to divide a single frame of an image signal into m fields (m is an even number which is at least two) and drive the image signal at m times speed is provided. The liquid crystal display device includes a circuit configured to compare an image signal of a concerned frame with an image signal of an immediately preceding frame for each pixel in a first field of the m fields, and performs correction so that when a gradation increases, the gradation becomes higher than the image signal of the concerned frame, and when the gradation decreases, the gradation becomes lower than the image signal of the concerned frame, a circuit configured to generate an inversion pattern for cyclically inverting a polarity of a drive voltage applied to a liquid crystal in an m/2 field including the first field of the m fields, and a circuit configured to perform inversion, so as to make the drive voltage applied to the liquid crystal in the m/2 field including the first field of the m fields and a drive voltage applied to the liquid crystal in remaining m/2 fields opposite in polarity to each other on the basis of the inversion pattern.

In the liquid crystal display device, at least two voltages applied to the liquid crystal are opposite in polarity to each other for each of adjacent pixels.

The present invention allows for substantially eliminating a direct current voltage component applied to a liquid crystal display element even though the overdriving is performed so that the occurrence of a spot, sticking, flicker, etc., can be reduced. Consequently, a liquid crystal display device capable of maintaining the display quality with stability can be provided.

Further features of the present invention will become apparent from the following description of exemplary embodiments with reference to the attached drawings.

### BRIEF DESCRIPTION OF THE DRAWINGS

FIG. 1 is a diagram showing an example use of a liquid crystal display device according to a first embodiment of the present invention.

FIG. 2 is a block diagram showing the liquid crystal display device of the first embodiment.

FIG. 3 is a diagram showing an example liquid crystal display element.

FIG. 4 is a block diagram showing an example of a liquid crystal drive unit shown in FIG. 2.

FIGS. 5(a)-(f) show the signal waveforms of individual units used in the first embodiment.

FIG. 6 is a block diagram showing a liquid crystal drive unit according to a second embodiment of the present invention.

FIGS. 7(a)-(d) show the signal waveforms of individual units used in the second embodiment.

FIGS. 8(a) and (b) show the signal waveforms of individual units used in a third embodiment of the present invention.

FIG. 9 shows an example temporal change in the gradation of an input image signal for a single pixel.

FIG. 10A shows example liquid crystal drive waveforms obtained by performing known field inversion driving.

FIG. 10B further shows example liquid crystal drive waveforms obtained by performing the known field inversion driving.

FIG. 11 shows an example of a liquid crystal response waveform shown and in FIG. 10.

### DESCRIPTION OF THE EMBODIMENTS

Next, embodiments of the present invention will be described with reference to the attached drawings. First, an example of field inversion driving performed by a liquid crystal display device according to an embodiment of the present invention will be described. Incidentally, according to another embodiment of the present invention, the advantage of the above-described embodiment can also be obtained through the liquid crystal display device performing (a) line inversion driving, so as to reverse the polarity of a driving voltage for each of adjacent lines, and (b) dot inversion driving, so as to reverse the polarity of a driving voltage for each of adjacent pixels.

### First Embodiment

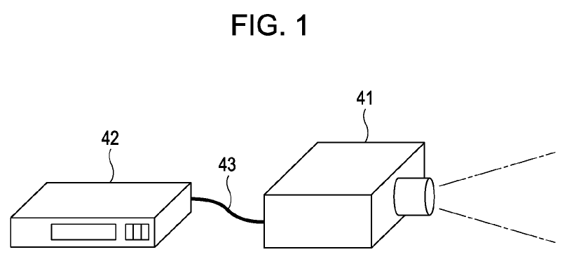

FIG. 1 shows an example use of a liquid crystal display device according to a first embodiment of the present invention. Namely, FIG. 1 shows a liquid crystal projector 41, which is provided as the above-described liquid crystal display device. The liquid crystal projector 41 is a device configured to emit a video signal transmitted thereto, as projected image light through which a user enjoys an image. A video player 42 is provided to generate the video signal transmitted to the liquid crystal projector 41. A video cable 43 is provided to transmit the video signal transmitted from the video player 42 to the liquid crystal projector 41.

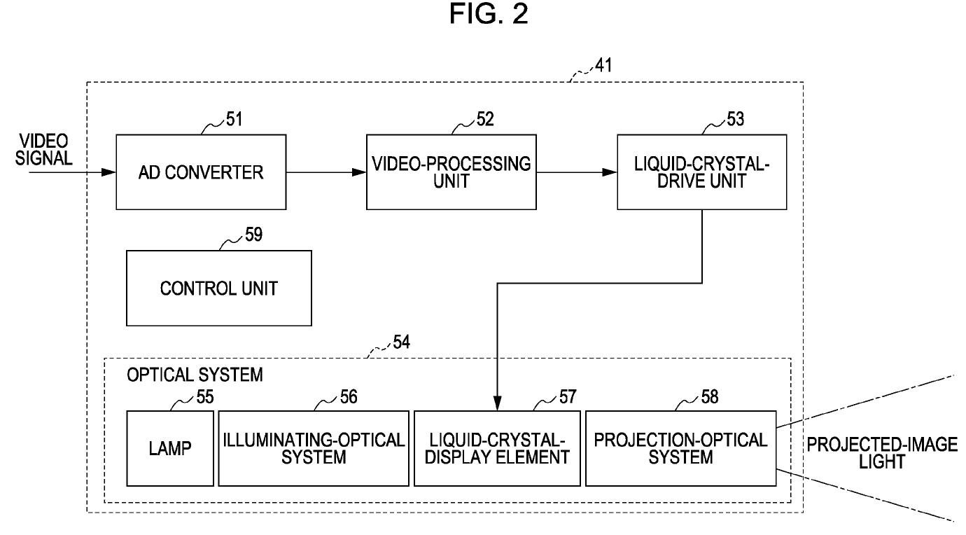

FIG. 2 is a block diagram showing the liquid crystal display device 41 of the first embodiment. FIG. 2 shows an analog to digital (AD) converter 51 configured to convert the transmitted video signal into a digital image signal suitable to be subjected to digital processing and an image-processing unit 52 configured to process the digital image signal into an image suitable to be enjoyed.

A liquid crystal drive unit 53 is configured to convert the digital image signal into a liquid crystal drive signal suitable to drive the liquid crystal display element 57, and an optical system 54 is configured to generate the projected video light. The optical system 54 includes a lamp 55 which is the source of the projected image light, an illumination optical system 56 configured to change light emitted from the lamp 55 into parallel light, etc.

The optical system 54 further includes a liquid crystal display element 57 configured to generate an image by modulating light, and a projection optical system 58 configured to externally emit modulated light generated by the liquid crystal display element 57, as the projected image light. The liquid crystal display element 57 will be described later. A control unit 59 is configured to control the operations and/or the power state of the entire liquid crystal projector 41.

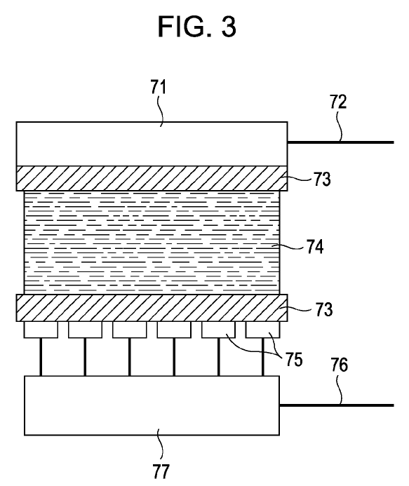

FIG. 3 is a schematic diagram showing an example of the liquid crystal display element 57. As shown in FIG. 3, a liquid crystal layer 74 is sandwiched between two electrodes 71 and 75 opposed to each other, and an alignment film 73 used to control the liquid crystal alignment of the liquid crystal layer 74 is provided on the liquid crystal layer 74 side of each of the two electrodes 71 and 75.

The electrode 75 provided on one side is configured as a pixel used to display image information. Plural individual pixel electronics 75 are shown in FIG. 3. The image signals supplied from a signal line 76 are sequentially supplied to the individual pixel electrodes 75 through a scan electrode circuit 77. Further, a direct current voltage is supplied from a line 72 to the electrode 71 opposed to the pixel electrode 75, as a common potential. The liquid crystal layer 74 is driven in accordance with the potential difference between the two electrodes 71 and 75 that are opposed to each other. According to the liquid crystal display device 41 of the first embodiment, an image is displayed by arranging liquid crystal display elements 57 in a two dimensional manner.

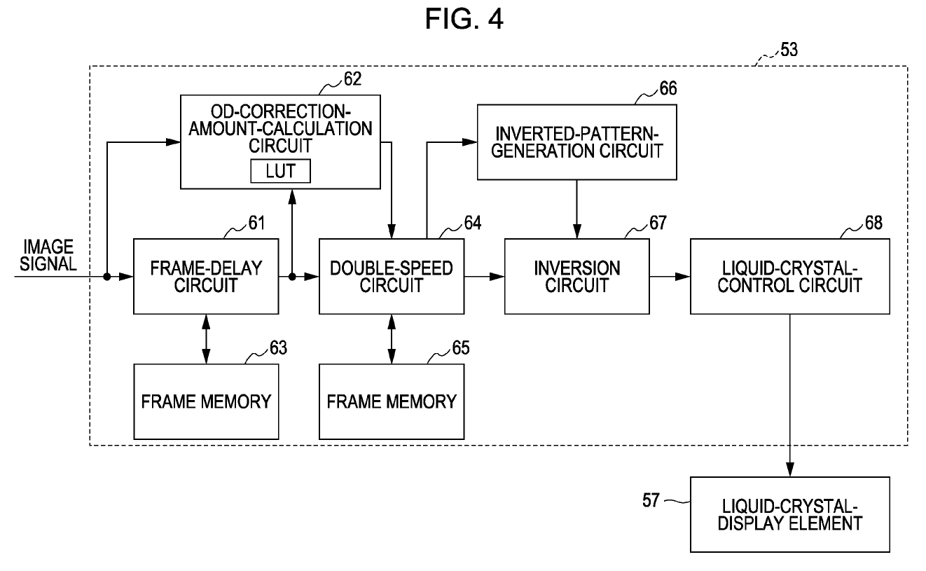

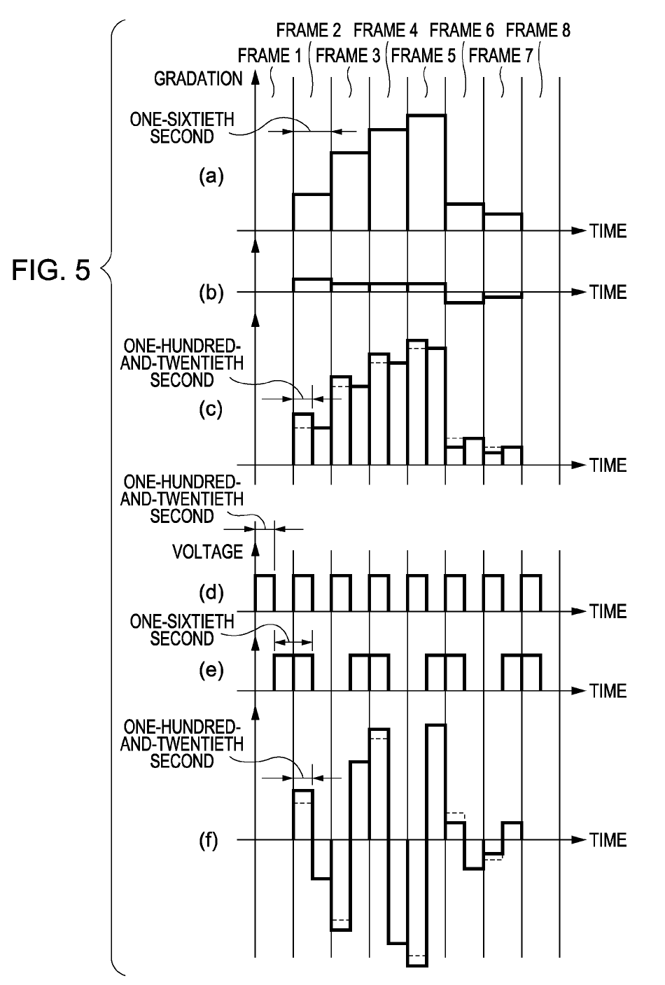

FIG. 4 is a block diagram showing an example of the liquid crystal drive unit 53 shown in FIG. 2. A digital image signal of 60 Hz is transmitted to the liquid crystal drive unit 53, where the frame of the digital image signal is updated every 1/60 second. The transmitted image signal is supplied to a frame delay circuit 61 and an overdrive (OD) correction amount calculation circuit 62. Part (a) of FIG. 5 shows an example change in the gradation of a predetermined pixel in a given eight frame period including frames 1 to 8 of the above-described image signal.

The frame delay circuit 61 stores the image signal information corresponding to a single frame in a frame memory 63. Further, the frame delay circuit 61 reads and transmits image signal information which is delayed by as much as a single frame, from the frame memory 63 to the OD correction amount calculation circuit 62 and a double speed circuit 64. The image signals corresponding to two frames adjacent to each other in terms of time are successively transmitted to the OD correction amount calculation circuit 62. The OD correction amount calculation circuit 62 calculates the amount of overdrive correction for each pixel on the basis of the combination of the gradations of the two frames by using a look-up table (LUT) in which data is stored in the OD correction amount calculation circuit 62.

In the above-described LUT, data on the relationship between the combination of the gradations of the two frames, the combination being obtained through an experiment in advance, and the appropriate overdrive correction amount corresponding to the above-described combination is written. Data on the calculated OD correction amount is transmitted to the double speed circuit 64. Part (b) of FIG. 5 shows the OD correction amount corresponding to the gradation change shown in Part (a) of FIG. 5.

The double speed circuit 64 performs correction, so as to achieve the overdriving after doubling the speed of the frame frequency of the transmitted image signal. First, the double speed circuit 64 stores data on the image signal transmitted from the frame delay circuit 61, the image signal corresponding to a single frame, in the frame memory 65 for each frame. Further, the double speed circuit 64 stores the OD correction amount data transmitted from the OD correction amount calculation circuit 62, the OD correction amount data corresponding to a single frame, in the frame memory 65 for each frame. The stored image signal data corresponding to the single frame and the OD correction amount data corresponding to the single frame are read by the double speed circuit 64 at a frequency of 120 Hz which is twice as high as an input frame frequency. Then, the read image signal data and the read OD correction amount data are transmitted to an inversion circuit 67, as the signals of the first and second fields that are shown near the part beneath the period of an input single frame.

First Field: Data obtained by adding the input image signal to the OD correction amount for each pixel is externally transmitted.

Second Field: Data on the input image signal is externally transmitted.

Part (c) of FIG. 5 shows an image signal in which the above-described input single frame is divided into two fields. As shown in Part (c) of FIG. 5, the input image signal and the OD correction amount are added to each other in the first field of each frame, and only the input image signal is shown in the second field. Further, the double speed circuit 64 transmits a timing signal to an inverted pattern generation circuit 66 so that a high level is attained in the first field and a low level is attained in the second field, so as to synchronize with the first field. The above-described timing signal is shown in Part (d) of FIG. 5.

The inverted pattern generation circuit 66 generates an inverted pattern signal used to invert a double speed image signal transmitted from the double speed circuit 64 on the basis of the timing signal transmitted from the double speed circuit 64, and transmits the inverted pattern signal to the inversion circuit 67. The inverted pattern signal is generated by reducing the frequency of the transmitted timing signal to half and shifting the phase of the timing signal by as much as 90°. The above-described inverted pattern signal is shown in Part (e) of FIG. 5.

The inversion circuit 67 inverts or not inverts the polarity of the double speed image signal transmitted from the double speed circuit 64 on the basis of the inverted pattern signal transmitted from the inverted pattern generation circuit 66. More specifically, the inversion circuit 67 inverts the polarity of the image signal for each field if the level of the inverted pattern signal is high. The inversion circuit 67 does not invert the polarity of the image signal if the level of the inverted pattern signal is low.

After being subjected to the above-described processing, the image signal is transmitted to a liquid crystal control circuit 68. Part (f) of FIG. 5 shows the above-described image signal. The first field is provided in the first part of a single frame and the second field is provided after the first frame. Further, as shown in Part (f) of FIG. 5, the polarities of the first and second fields are inverted within a single frame and the polarity of the first field in which the OD correction is performed is changed for each frame. More specifically, the polarity of the first field is switched between positive and negative for each frame.

The liquid crystal control circuit 68 performs digital to analog (D/A) conversion and/or level conversion for the transmitted image signal, and generates the drive signal corresponding to the image signal shown in Part (f) of FIG. 5, that is, a drive signal appropriate to drive the liquid crystal display element 57 located after the liquid crystal control circuit 68. The drive signal generated to drive the liquid crystal display element 57 is transmitted from the liquid crystal control circuit 68 to the liquid crystal display element 57, which causes the gradation change corresponding to the drive signal.

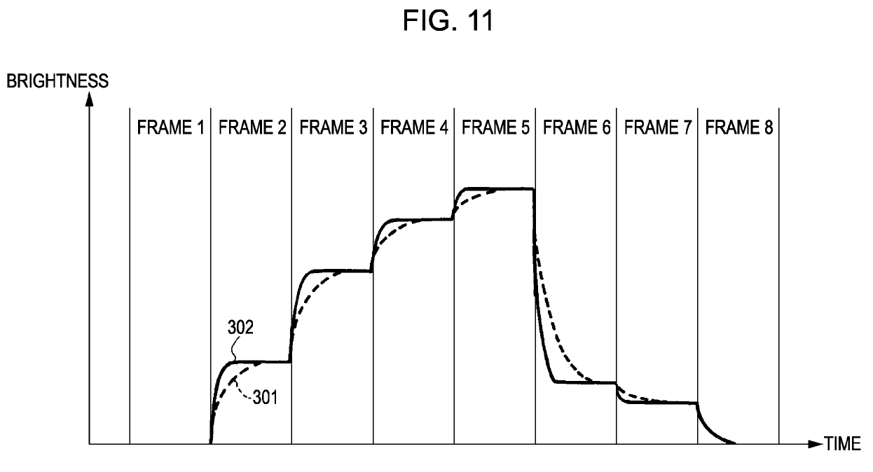

Since the overdriving is adopted in the first embodiment, the gradation change becomes the track of the solid line 302 shown in FIG. 11. Further, it becomes possible to achieve a liquid crystal response which is steeper and more appropriate to display video than that obtained through known normal driving for which no overdriving is performed, as indicated by the broken line 301 shown in FIG. 11.

Further, according to the first embodiment, the liquid crystal display element 57 is driven at half the frequency of a double speed image and in a polarity out of phase by as much as 90° on the basis of the inverted pattern signal shown in Part (e) of FIG. 5, the inverted pattern signal being generated by the inverted pattern generation circuit 66. Therefore, in regard to the first field of the two fields provided in a single frame of the input image signal, the polarity of the first field in which the OD correction is performed is switched between positive and negative for every single frame.

Since the double speed driving is adopted in the first embodiment, the field is divided into the single first field and the single second field. Usually, when a single frame is divided into m fields (m is an even number which is at least two) and driven at mx speed, the frame is divided into the first m/2 fields and the second m/2 fields. An embodiment of the present invention, where the expression m=4 holds, will be described later.

According to the first embodiment, in the first field of the single frame, the liquid crystal display element 57 is driven in each of the positive polarity and the negative polarity at the same probability for each frame, as a phenomenon independent of the image signal level fluctuations. Therefore, the voltage application lacking in balance, such as the overdriving, is equally distributed for each of the positive polarity and the negative polarity for every single frame.

Therefore, even though the overdriving is continued over an extended time period, it becomes possible to statistically reduce the leaning to a specific polarity and substantially reduce the application of a direct current electric field to the liquid crystal display element 57. Therefore, the occurrence of a spot, sticking, flicker, etc., can be reduced so that the display quality can be maintained with stability.

### Second Embodiment

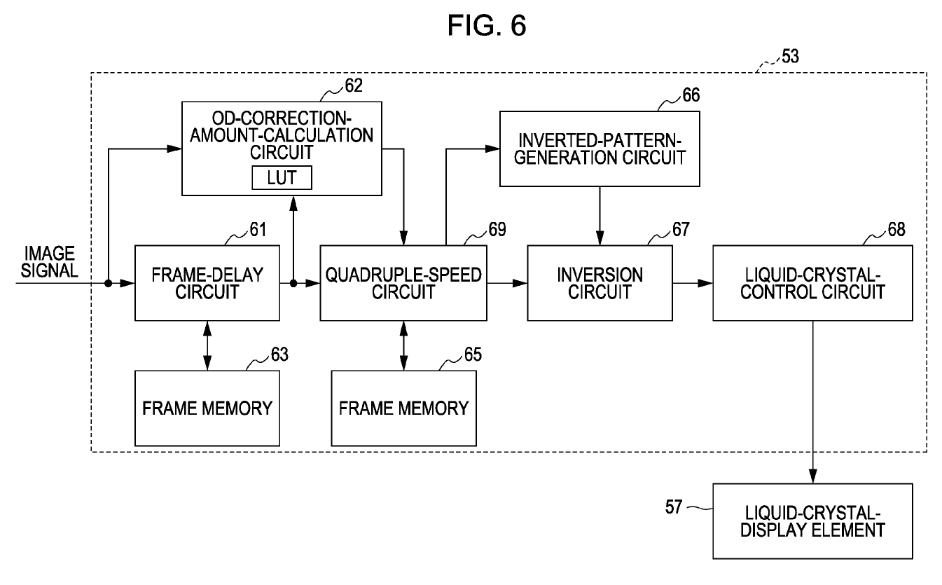

Next, a second embodiment of the present invention will be described. The configuration of the second embodiment is the same as that of the first embodiment except that the configuration of the liquid crystal drive unit 53 is replaced with a configuration shown in FIG. 6. Further, the same components shown in FIG. 6 as those shown in FIG. 4 are designated by the same reference numerals. FIG. 6 is different from FIG. 4 in that the double speed circuit 64 is replaced with a quadruple speed circuit 69. That is to say, FIG. 6 shows an example where a single frame is divided into m fields (m=4).

The quadruple speed circuit 69 performs correction, so as to perform the overdriving after quadrupling the speed of the frame frequency of a transmitted image signal. First, the quadruple speed circuit 69 stores data on the image signal transmitted from the frame delay circuit 61, the image signal corresponding to a single frame, in the frame memory 65 for each frame. Further, the quadruple speed circuit 69 stores the OD correction amount data transmitted from the OD correction amount calculation circuit 62, the OD correction amount data corresponding to a single frame, in the frame memory 65 for each frame. The stored image signal data corresponding to the single frame and the OD correction amount data corresponding to the single frame are read by the quadruple speed circuit 69 at a frequency of 240 Hz which is four times as high as the input frame frequency. Then, the read image signal data and the read OD correction amount data are transmitted to the inversion circuit 67, as the signals of four fields that are shown near the part beneath the period of the input single frame.

First Field: Data obtained by adding the input image signal to the OD correction amount for each pixel is externally transmitted.

Second Field: Data on the input image signal is externally transmitted. Third Field: Data on the input image signal is externally transmitted. Fourth Field: Data on the input image signal is externally transmitted. The second to fourth fields correspond to the second field of the first embodiment.

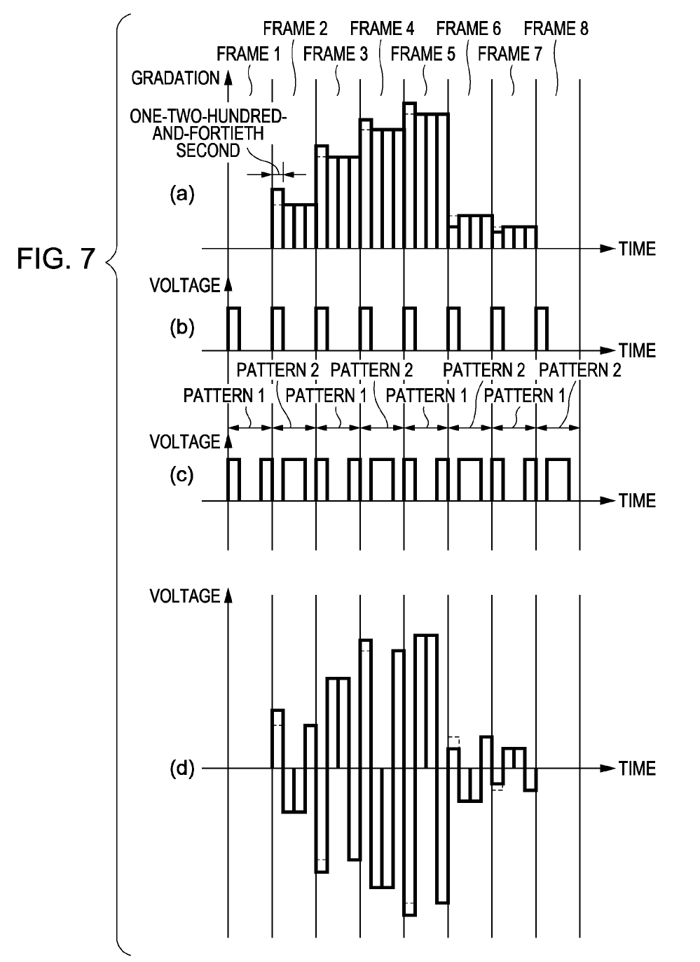

Part (a) of FIG. 7 shows an image signal in which the above-described input single frame is divided into four fields. Further, the quadruple speed circuit 69 transmits a timing signal to the inverted pattern generation circuit 66 so that a high level is attained in the first field and a low level is attained in the second to fourth fields, so as to synchronize with the first field. The above-described timing signal is shown in Part (b) of FIG. 7.

In the second embodiment, the change in the gradation of the predetermined pixel within the given eight frame period including frames 1 to 8 of the above-described image signal is the same as that shown in Part (a) of FIG. 5 as described in the first embodiment. Further, the OD correction amount of the second embodiment is also the same as that shown in Part (b) of FIG. 5.

The inverted pattern generation circuit 66 generates an inverted pattern signal used to invert a quadruple speed image signal transmitted from the quadruple speed circuit 69 on the basis of the timing signal transmitted from the quadruple speed circuit 69, and transmits the inverted pattern signal to the inversion circuit 67. The above-described inverted pattern signal becomes the following two pattern signals that are out of phase by as much as 180° for every transmitted timing signal and that are alternately transmitted from the inverted pattern generation circuit 66.

Pattern 1: HIGH field, LOW field, LOW field, and HIGH field
Pattern 2: LOW field, HIGH field, HIGH field, and LOW field
The above-described inverted pattern signal is shown in Part (c) of FIG. 7.

The inversion circuit 67 inverts and/or non inverts the polarity of the quadruple speed image signal transmitted from the quadruple speed circuit 69 on the basis of the inverted pattern signal transmitted from the inverted pattern generation circuit 66. More specifically, the inversion circuit 67 inverts the polarity of the image signal for each field if the level of the inverted pattern signal is high. Further, the inversion circuit 67 does not invert the polarity of the image signal if the level of the inverted pattern signal is low. After being subjected to the above-described processing, the image signal is transmitted to the liquid crystal control circuit 68. Part (d) of FIG. 7 shows the above-described image signal.

As shown in Part (d) of FIG. 7, the number of fields of positive polarity is the same as that of fields of negative polarity. Further, as is the case with the first embodiment, the polarity of the first field in which the OD correction is performed is switched between positive and negative for every frame.

In the second embodiment, a single frame is divided into four frames, as described above. In the single frame, therefore, the polarity of m/2 fields (=2 fields) including the first field is the reverse of that of m/2 fields (=2 fields) including the second field, as shown in Part (d) of FIG. 7.

The liquid crystal control circuit 68 performs the D/A conversion and/or the level conversion for the transmitted image signal, and generates the drive signal corresponding to the image signal, that is, the drive signal appropriate to drive the liquid crystal display element 57 located after the liquid crystal control circuit 68. Since the overdriving is also adopted in the second embodiment, a steep liquid crystal response appropriate to display video can be achieved.

Even though the overdriving is continued over an extended time period, as is the case with the first embodiment, the second embodiment also allows for statistically reducing the leaning to the specific polarity, and substantially reducing the application of the direct current electric field to the liquid crystal display element 57.

### Third Embodiment

Next, a third embodiment of the present invention will be described. The third embodiment is identical with the first embodiment except that the inverted pattern generation circuit 66 provided in the liquid crystal drive unit 53 is changed as below. Namely, when a single frame is divided into m fields (m is an even number which is at least 2) in the third embodiment, the number of the m fields is two, as is the case with the first embodiment. However, the third embodiment is different from the first embodiment in that the polarity of the first field in which the OD correction is performed is changed for every predetermined number of frames in place of a single frame.

The inverted pattern generation circuit 66 used in the third embodiment generates the inverted pattern signal used to invert the double speed image signal transmitted from the double speed circuit 64 on the basis of the timing signal transmitted from the double speed circuit 64, and transmits the inverted pattern signal to the inversion circuit 67. The inverted pattern signals are externally transmitted by turns in a cycle of four frames with reference to the transmitted timing signal, where the inverted pattern signals are externally transmitted in two patterns, as below.

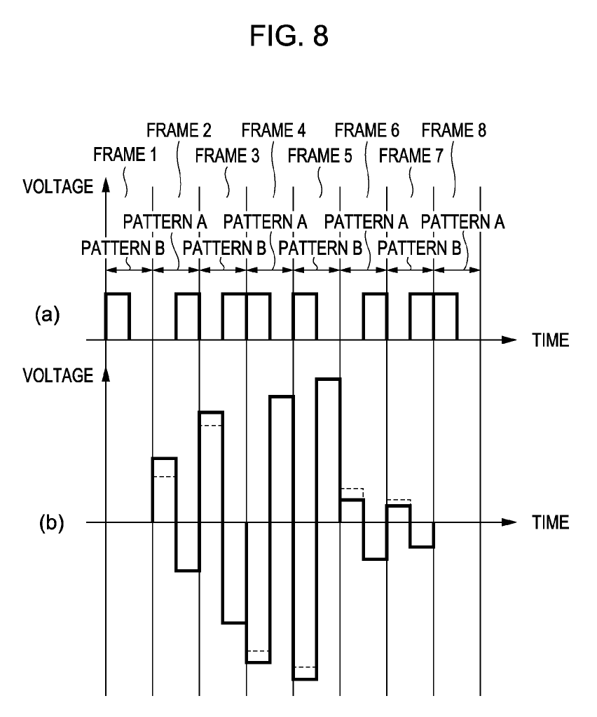

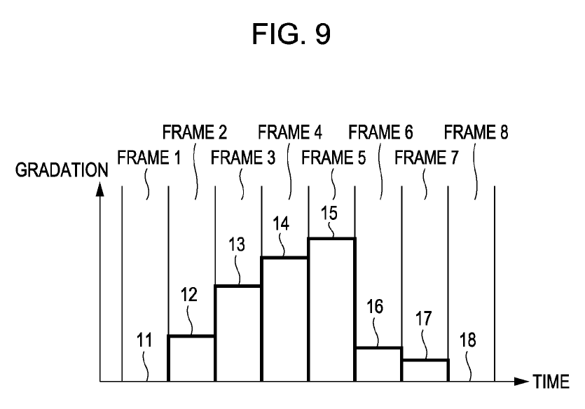

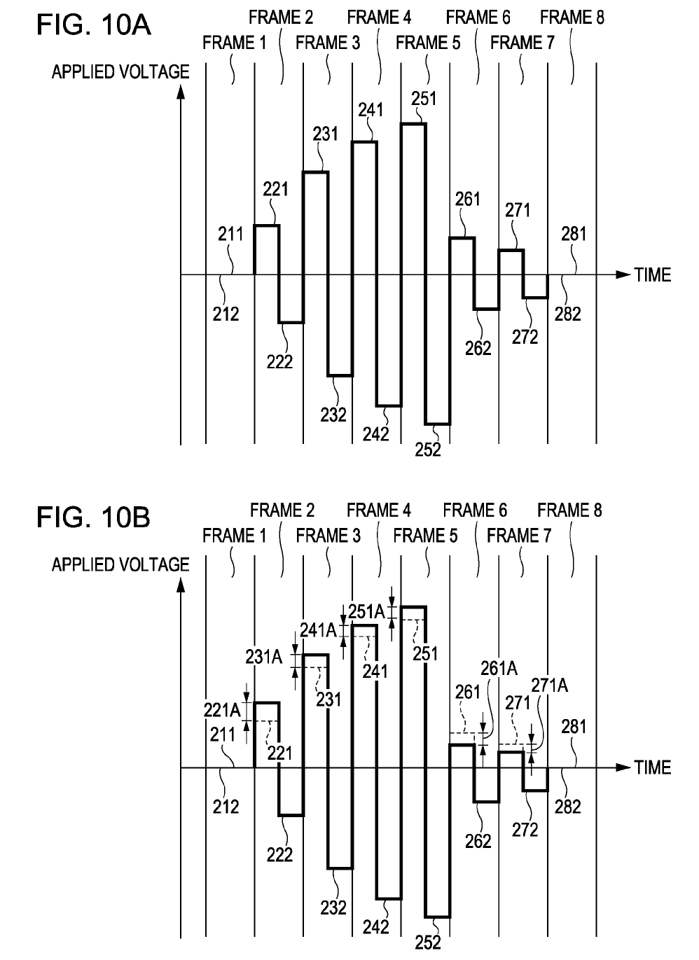

Pattern A: LOW field and HIGH field
Pattern A: LOW field and HIGH field
Pattern B: HIGH field and LOW field
Pattern B: HIGH field and LOW field
The above-described inverted pattern signals are shown in Part (a) of FIG. 8.

The inversion circuit 67 performs the same operations as those performed in the first embodiment. Namely, the inversion circuit 67 inverts and/or non inverts the image signal (shown in Part (c) of FIG. 5) transmitted from the double speed circuit 64 on the basis of the inverted pattern signal, and transmits the image signal subjected to the inversion processing or the non inversion processing to the liquid crystal control circuit 68. The above-described image signal is shown in Part (b) of FIG. 8. The liquid crystal control circuit 68 performs the DA conversion and/or the level conversion for the transmitted image signal, as is the case with the first and second embodiments, and drives the liquid crystal display element 57 by using the drive signal corresponding to the image signal.

Further, in the third embodiment, the change in the gradation of a predetermined pixel within a given eight frame period including frames 1 to 8 of the above-described image signal is the same as that shown in Part (a) of FIG. 5 as described in the first embodiment. Further, the OD correction amount of the third embodiment is the same as that shown in Part (b) of FIG. 5. Still further, the above-described image signals of the first and second fields in the double speed circuit 64 are the same as those shown in Part (c) of FIG. 5, and the timing signal generated in the double speed circuit 64 is the same as that shown in Part (d) of FIG. 5. In the third embodiment, the same advantage as those of the first and second embodiments can also be obtained and a steep liquid crystal response appropriate to display video can also be attained.

In the third embodiment, the polarity of the first field is the reverse of that of the second field, where the first and second fields are provided in a single frame, as is the case with the first embodiment. Further, the polarity of the first field in which the OD correction is performed is changed for every two frames, as shown in Part (b) of FIG. 8. Thus, according to an embodiment of the present invention, the polarity of the first field in which the OD correction is performed may be changed for every two frames in place of a single frame. Further, without being limited to the two frames, the polarity of the first field in which the OD correction is performed may be changed for every predetermined number of frames, where the predetermined number is larger than two (e.g., for every three or four frames).

Even though the overdriving is continued over an extended time period, as is the case with the first and second embodiments, the third embodiment also allows for statistically reducing the leaning to the specific polarity, and substantially reducing the application of the direct current electric field to the liquid crystal display element 57.

While the present invention has been described with reference to exemplary embodiments, it is to be understood that the invention is not limited to the disclosed exemplary embodiments. For example, even though the above-described embodiments exemplarily illustrate the double speed driving and the quadruple speed driving, the speed at which the driving is performed may be increased. Namely, even though the single frame is divided into two fields and four fields in the above-described embodiments, the number of the fields may be five or more. The scope of the following claims is to be accorded the broadest interpretation so as to encompass all modifications and equivalent structures and functions.

This application claims the benefit of Japanese Application No. 2007 301783 filed on Nov. 21, 2007, which is hereby incorporated by reference herein in its entirety.

What is claimed is:

1. A liquid crystal display device configured to divide a single frame of an image signal into m fields (m is an even number which is at least two) and to drive the image signal at m times speed, the liquid crystal display device comprising:
a circuit configured to compare an image signal of a given frame with an image signal of an immediately preceding frame for each pixel in a first field of the m fields, and to perform correction so that when a gradation increases, the gradation becomes higher than the image signal of the given frame, and when the gradation decreases, the gradation becomes lower than the image signal of the given frame;
a circuit configured to generate an inversion pattern for cyclically inverting a polarity of a drive voltage applied to a liquid crystal in m/2 fields including the first field of the m fields; and
a circuit configured to perform inversion, so as to make the drive voltage applied to the liquid crystal in the m/2 fields including the first field of the m fields and a drive voltage applied to the liquid crystal in remaining m/2 fields of the m fields opposite in polarity to each other on the basis of the inversion pattern.

2. The liquid crystal display device according to claim 1, wherein the circuit configured to perform inversion so as to invert the polarity of the drive voltage inverts the polarity of the drive voltage for each field over the m fields.

3. The liquid crystal display device according to claim 1, wherein the circuit configured to generate the inversion pattern generates an inversion pattern for inverting the polarity of the drive voltage of the m/2 fields including the first field of the m fields for each frame.

4. The liquid crystal display device according to claim 1, wherein at least two voltages applied to the liquid crystal are opposite in polarity to each other for each of adjacent pixels.

5. The liquid crystal display device according to claim 1, wherein at least two voltages applied to the liquid crystal are opposite in polarity to each other for each of adjacent lines.

6. The liquid crystal display device according to claim 1, wherein m=2.

7. The liquid crystal display device according to claim 1, wherein m=4.

8. The liquid crystal display device according to claim 7, wherein an inversion pattern applied to four fields of a first frame corresponds to a pattern of high, low, low, and high, in that order, and an inversion pattern applied to four fields of another frame corresponds to a pattern of low, high, high, and low, in that order.

9. A method of driving a liquid crystal display device configured to divide a single frame of an image signal into m fields (m is an even number which is at least two) and drive the image signal at m times speed, the method comprising steps of:
comparing an image signal of a given frame with an image signal of an immediately preceding frame for each pixel in a first field of the m fields, and performing correction so that when a gradation increases, the gradation becomes higher than the image signal of the given frame, and when the gradation decreases, the gradation becomes lower than the image signal of the given frame; and
performing inversion, so as to make a drive voltage applied to a liquid crystal in m/2 fields including the first field of the m fields and a drive voltage applied to the liquid crystal in remaining m/2 fields of the m fields opposite in polarity to each other, and cyclically inverting a polarity of the drive voltage applied to the liquid crystal in the m/2 fields including the first field.

10. An apparatus comprising:
input means for inputting an image signal;
dividing means for dividing a frame of the image signal into a first field and a second field;
overdrive correcting means for overdrive correcting the first field but not the second field; and
inverting means for inverting polarity for the first field but not the second field of a first frame of the image signal and for inverting polarity for the second field but not the first field of a successive frame of the image signal.

11. An apparatus according to claim 10, further comprising driving a liquid crystal display in accordance with output of said inverting means.

12. An apparatus according to claim 10, wherein said overdrive correcting means comprises means for determining an overdrive correction amount using a look-up table, and means for adding the overdrive correction amount to the input image signal.

13. An apparatus comprising:
input means for inputting an image signal;
dividing means for dividing a frame of the image signal into four fields;
overdrive correcting means for overdrive correcting only the first field of a frame; and
inverting means for selectively applying to a frame of the input image signal one of a first pattern for inverting polarity in which only two of the four fields are inverted and a second pattern for inverting polarity in which the other two of the four fields are inverted,
wherein said inverting means alternately selects the first pattern and the second pattern for successive frames of the input image signal.

14. An apparatus according to claim 13, further comprising driving a liquid crystal display in accordance with output of said inverting means.

15. An apparatus according to claim 13, wherein said overdrive correcting means comprises means for determining an overdrive correction amount using a look-up table, and means for adding the overdrive correction amount to the input image signal.

16. An apparatus according to claim 15, wherein in the first pattern, only the second and third fields are inverted, and in the second pattern, only the first and fourth fields are inverted.

17. An apparatus according to claim 13, wherein each of the four fields are one fourth as long in time as the frame.

18. An apparatus according to claim 17, wherein in the first pattern, only the second and third fields are inverted, and in the second pattern, only the first and fourth fields are inverted.

19. An apparatus according to claim 13, wherein in the first pattern, only the second and third fields are inverted, and in the second pattern, only the first and fourth fields are inverted.

20. An apparatus according to claim 19, wherein each of the four fields are one fourth as long in time as the frame.
